(19) United States
(12) Patent Application Publication
(10) Pub. No.: US 2021/0343149 A1
(43) Pub. Date: Nov. 4, 2021

(54) DRIVING EARLY WARNING METHOD AND APPARATUS, ELECTRONIC DEVICE, AND COMPUTER STORAGE MEDIUM

(71) Applicant: Shanghai SenseTime Lingang Intelligent Technology Co., Ltd., Shanghai (CN)

(72) Inventors: Mingxing PENG, Shanghai (CN); Sheng ZHANG, Shanghai (CN)

(21) Appl. No.: 17/377,615

(22) Filed: Jul. 16, 2021

Related U.S. Application Data
(63) Continuation of application No. PCT/CN2020/092684, filed on May 27, 2020.

(30) Foreign Application Priority Data
Sep. 30, 2019 (CN) 201910944299.9

(51) Int. Cl. G08G 1/16; G06K 9/00; G06K 9/62; G08G 1/01; G08G 1/048; H04L 29/08; G06F 16/903; B60W 50/14; B60W 40/09

(52) U.S. Cl. CPC G08G 1/164; B60W 2555/20; G06K 9/6215; G06K 9/00281; G08G 1/012; G08G 1/0129; G08G 1/048; H04L 67/12; G06F 16/90335; B60W 50/14; B60W 40/09; B60W 2540/30; B60W 2540/043; B60W 2556/45; B60W 2556/10; G06K 9/00845

(57) ABSTRACT

Provided are a driving early warning method and apparatus, an electronic device, and a computer storage medium. The method comprises: acquiring real-time position information of a vehicle (101); predicting future position information according to the real-time position information (102); according to a first mapping relationship between a geographical location and the dangerous driving historical data and which is stored in a database, determining, in the database, first dangerous driving historical data corresponding to the future position information (103); generating first driving early warning information according to the determined first dangerous driving historical data (104); and sending the first driving early warning information to the vehicle (105).

### CROSS-REFERENCE TO RELATED APPLICATIONS

This is a continuation of International Application No. PCT/CN2020/092684, filed on May 27, 2020, which is based on and claims priority to Chinese Patent Application No. 201910944299.9, filed on Sep. 30, 2019. The contents of International Application No. PCT/CN2020/092684 and Chinese Patent Application No. 201910944299.9 are incorporated herein by reference in their entireties.

### TECHNICAL FIELD

The present disclosure relates to data analysis techniques for vehicle systems, and more particularly, to a method and apparatus for driving warning, an electronic device, and a computer storage medium.

### BACKGROUND

The traffic accident is an important factor endangering the safety of human life, and the driving warning to the driver may reduce the probability of accidents and improve the driving safety.

### SUMMARY

An embodiment of the present disclosure provides a method for driving warning. The method comprises: acquiring real-time location information of a vehicle; predicting future location information based on the real-time location information; determining first dangerous driving history data corresponding to the future location information according to a first mapping relationship between a geographical location and dangerous driving history data stored in a database; generating first driving warning information based on the determined first dangerous driving history data; and sending the first driving warning information to the vehicle.

An embodiment of the present disclosure further provides an apparatus for driving warning. The device includes an acquiring module, a processing module, and a sending module.

The acquiring module is configured to acquire real-time location information of a vehicle.

The processing module is configured to predict future location information based on the real-time location information; determine first dangerous driving history data corresponding to the future location information according to a first mapping relationship between a geographical location and the dangerous driving history data stored in the database; and generate first driving warning information based on the determined first dangerous driving history data.

The sending module is configured to send the first driving warning information to the vehicle.

An embodiment of the present disclosure further provides an electronic device.

The electronic device includes a processor and a memory for storing a computer program executable by the processor. The processor is configured to execute the computer program to perform any of the methods for driving warning described above.

An embodiment of the present disclosure further provides a computer storage medium. The computer storage medium has stored thereon a computer program which, when executed by a processor, implements any of the methods for driving warning described above.

An embodiment of the present disclosure further provides a computer program product. The computer program product includes computer program instructions which, when executed, cause a computer to implement any of the methods for driving warning described above.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of the specification, illustrate embodiments consistent with the present disclosure and, together with the description, serve to illustrate the technical solution of the disclosure.

FIG. 1 is a flow chart of a method for driving warning according to an embodiment of the present disclosure;

FIG. 2 is a structural diagram of an application scenario according to an embodiment of the present disclosure;

FIG. 3 is a structural diagram of a device for driving warning according to an embodiment of the present disclosure; and

FIG. 4 is a structural diagram of an electronic device according to an embodiment of the present disclosure.

### DETAILED DESCRIPTION

The embodiments of the present disclosure are described in further detail below with reference to the accompanying drawings and examples. It is to be understood that the embodiments provided herein are merely illustrative of the embodiments of the disclosure and are not intended to limit the embodiments of the disclosure. In addition, the following examples are provided for carrying out some embodiments of the present disclosure, rather than all embodiments for carrying out the present disclosure. The technical solutions described in the embodiments of the present disclosure may be carried out in any combination without conflict.

It should be noted that in the embodiments of the present disclosure, the terms “comprises,” “comprising,” or any other variation thereof, are intended to encompass a non-exclusive inclusion, such that a method or a device comprising a list of elements includes not only the elements expressly recited, but also other elements not expressly listed, or elements inherent to the method or device. Without more limitations, an element defined by the statement “comprising one . . . ” not rule out additional relevant elements in the method or device comprising the element (e.g., a step in the method, or an element in the device such as a part of a circuit, part of a processor, part of a program or software, etc.).

For example, the method for driving warning provided in the embodiment of the present disclosure includes a series of steps. However, the method for driving warning provided in the embodiment of the present disclosure is not limited to the steps described. Similarly, the apparatus for driving warning provided in the embodiment of the present disclosure includes a series of modules. However, the apparatus provided in the embodiment of the present disclosure is not limited to the modules specifically described, and may further include modules for acquiring the related information or for processing based on the information.

The term “and/or,” as used herein, is merely an association that describes an associated object, meaning that there may be three relationships. For example, A and/or B may mean that A alone, both A and B, and B alone, are present. Additionally, the term “at least one” as used herein denotes any combination of: any one of multiple objects, or at least two of multiple objects. For example, including at least one of A, B, or C may denote the inclusion of any one or more elements selected from the group consisting of A, B, and C.

The application scenarios of the embodiments of the present disclosure may be in a computer system consisting of a vehicle-mounted device and a cloud platform, and may operate with numerous other general-purpose or special-purpose computing system environments or configurations. Exemplarily, a vehicle-mounted device may be a thin client, a thick client, a microprocessor-based system, a minicomputer system, etc., mounted on a vehicle; and a cloud platform may be a distributed cloud computing environment including a minicomputer system or a mainframe computer system, etc.

The vehicle-mounted device, cloud platform, or the like may be described in the general context of computer system executable instructions (such as program modules) executed by a computer system. Generally, program modules may include routines, programs, target programs, components, logic, data structures, etc., and perform particular tasks or implement particular abstract data types. In a cloud platform, tasks are performed by remote processing devices linked through a communication network. In a cloud platform, program modules may be located on a local or remote computing system storage medium including a storage device.

In the embodiment, the vehicle-mounted device may be communicatively connected to a sensor, a locating device, or the like, of the vehicle, and the vehicle-mounted device may acquire data collected by the sensor of the vehicle, geographical location information reported by the locating device, or the like through the communicative connection. Exemplarily, the sensor of the vehicle may be at least one of a millimeter wave radar, a laser radar, a camera, or the like. The locating device may be a device for providing a locating service based on at least one of a Global Positioning System (GPS), a Beidou satellite navigation system, or a Galileo satellite navigation system.

In some embodiments of the present disclosure, a method for driving warning is provided. The embodiments of the present disclosure may be applied to the fields of driving warning, vehicle operation management, driver management, or the like.

The method for driving warning in the embodiment of the disclosure may be applied to a cloud platform which is communicatively connected to the vehicle-mounted device.

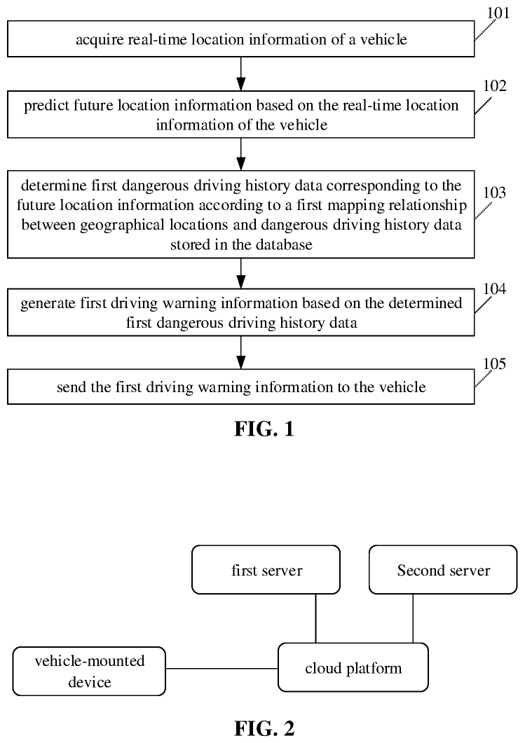

FIG. 1 is a flow chart of a method for driving warning according to an embodiment of the present disclosure. As shown in FIG. 1, the flow may include steps 101 to 105.

In 101, real-time location information of a vehicle is acquired.

In the embodiment of the present disclosure, the real-time location information of the vehicle is used to represent the current geographic location of the vehicle, and the real-time location information of the vehicle may take the form of longitude and latitude data or other types of geographic location data. In practical applications, the vehicle-mounted device may report the real-time location information to the cloud platform after acquiring the real-time location information reported by the locating device.

In one example, the vehicle-mounted device may be an Advanced Driving Assistant System (ADAS) provided in the vehicle, which may obtain real-time location information of the vehicle from a locating device of the vehicle. The ADAS may send the vehicle travel data including the real-time location information of the vehicle to the cloud platform, such that the cloud platform may receive the real-time location information of the vehicle.

It should be noted that the contents of the above description are merely illustrative of an implementation of acquiring real-time location information of a vehicle by a cloud platform, and the embodiments of the present disclosure are not limited thereto.

In 102, future location information is predicted based on the real-time location information of the vehicle.

Here, the future location information indicates a location at which the vehicle may travel at a time point in the future. The distance between the location in the future location information and the real-time location of the vehicle is related to the current travel speed of the vehicle. In practical applications, the cloud platform may acquire the real-time location information of the vehicle, and may further acquire the current travel speed of the vehicle sent by the vehicle-mounted device. For example, the ADAS on the vehicle may determine the travel speed of the vehicle based on the change of the vehicle location per unit time, and then send the vehicle travel data including the current travel speed of the vehicle to the cloud platform. The cloud platform may predict a location that the vehicle may reach within a set time, i.e., future location information, based on the real-time location of the vehicle and the current travel speed of the vehicle. The setting time may be set according to an actual application demand. For example, the range of the setting time may be 10 seconds to 60 seconds.

In 103, first dangerous driving history data corresponding to the future location information is determined according to a first mapping relationship between a geographical location and the dangerous driving history data stored in the database.

In the embodiment of the present disclosure, the dangerous driving history data may include dangerous driving data when at least one driver passes a corresponding geographic location. Exemplarily, the dangerous driving history data may represent the dangerous driving data when a driver passes a corresponding geographical location. The dangerous driving history data may further represent the dangerous driving data when different drivers pass through the corresponding geographical location. Herein, for the same geographical location, each driver may pass through the same geographical location once or more times. Thus, the dangerous driving data when each driver passes through the geographical location may be the dangerous driving data when each driver passes through the geographical location once or more times.

The dangerous driving data indicates a dangerous driving condition that has occurred at a future location of the vehicle. Exemplarily, the dangerous driving data of the vehicle includes at least one of: a lane departure warning, a forward collision warning, an overspeed warning, a pedestrian in front of the vehicle, a backward collision warning, an obstacle in front of the vehicle, fatigue driving data of the driver, distracted driving data of the driver, or dangerous action data of the driver. Exemplarily, the fatigue driving data of the driver may be yawning or other fatigue travel behavior, the distracted driving data of the driver may be a distracted travel behavior such as smoking or drinking water, and the dangerous operation data of the driver may be a behavior such as making a phone call or making up.

It may be seen that the first dangerous driving history data indicates a dangerous driving condition that has occurred at a future location of the vehicle, such that the dangerous driving condition which would easily occur at the road ahead may be reflected accurately and reliably.

In practical applications, when generating the dangerous driving history data, the vehicle-mounted device provided in the vehicle may send the dangerous driving history data and the geographical location corresponding to the dangerous driving history data to the cloud platform. For example, the vehicle-mounted device may include at least one of a DMS or an ADAS, and the DMS may include a vehicle-mounted camera with the image acquisition direction of the vehicle-mounted camera facing the cabin. The DMS may analyze the driver image captured by the vehicle-mounted camera, and when determining based on the analysis result that the dangerous driving condition occurs, may generate the dangerous driving history data and determine the geographical location corresponding to the dangerous driving history data generated by the DMS. The DMS may send the dangerous driving history data and the geographic location corresponding to the dangerous driving history data to the cloud platform. Exemplarily, the dangerous driving history data generated by the DMS may include at least one of: fatigue driving data of the driver, distracted driving data of the driver, and dangerous action data of the driver. The ADAS may include a camera mounted on the vehicle and the image acquisition direction is toward the outside of the vehicle. The ADAS may perform an analysis according to the outside environment image acquired by the camera. When it is determined that a dangerous driving condition occurs according to an analysis result, the ADAS may generate dangerous driving history data, and determine a geographical location corresponding to the dangerous driving history data generated by the ADAS. The ADAS may send the dangerous driving history data and the geographical location corresponding to the dangerous driving history data to the cloud platform. Exemplarily, the dangerous driving history data generated by the ADAS may include at least one of: lane departure, forward collision, overspeed, or a pedestrian in front of the vehicle.

In some optional embodiments of the present disclosure, before determining the dangerous driving history data corresponding to the future location information, the method further includes: receiving the dangerous driving history data sent by the vehicle-mounted device and the geographical location corresponding to the dangerous driving history data, and establishing a first mapping relationship between the received geographical location and the dangerous driving history data in a database.

It may be understood that the first mapping relationship between the received geographical location and the dangerous driving history data is established in the database, such that the dangerous driving history data at the road ahead may be directly determined according to the first mapping relationship after the future location information of the vehicle is acquired, and then a warning may be issued in time.

In 104, first driving warning information is generated based on the determined first dangerous driving history data.

In the embodiment, the first driving warning information may be used to indicate a dangerous driving condition which has occurred at a future location of the vehicle. For example, the first dangerous driving history data indicates that a lane departure, a forward collision, an overspeed, or a pedestrian in front of the vehicle has occurred at a future location of the vehicle. Exemplarily, the first driving warning information may be represented in the form of prompt information for indicating that a lane departure, a forward collision, an overspeed, or a pedestrian in front of the vehicle has occurred at a future location of the vehicle.

In 105, the first driving warning information is sent to the vehicle.

In practical applications, after the cloud platform sends the first driving warning information to the vehicle, the vehicle may display the first driving warning information through the vehicle-mounted display screen, or may broadcast the first driving warning information through voice.

In practical applications, steps 101 to 105 may be implemented based on a processor or the like of a cloud platform, which may be at least one of: an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor.

It may be seen that in the embodiment of the disclosure, not only the real-time location information of the vehicle is acquired, but also the future location of the vehicle is predicted, and the first driving warning information is generated according to the dangerous driving history data corresponding to the future location of the vehicle. The dangerous driving history data indicates a dangerous driving condition which has occurred at the future location of the vehicle, such that it may reflect accurately and reliably the dangerous driving condition which would easily occur at the road ahead. Further, after the vehicle receives the first driving warning information, the driver of the vehicle may learn accurately and reliably that dangerous driving condition would easily occur at the road ahead, such that the driver may take countermeasures in advance, thereby improving the safety of vehicle driving.

In some optional embodiments of the present disclosure, after predicting the future location information based on the real-time location information, the method may further include: acquiring at least one of weather condition information or traffic condition information of a geographic region corresponding to the future location information; and sending at least one of the weather condition information or traffic condition information of the geographical area corresponding to the future location information to the vehicle.

In the embodiment of the disclosure, the weather condition information includes, but is not limited to, rain, snow, fog, sunny day, night, cloudy day, or the like, and the traffic condition information includes, but is not limited to, uphill, downhill, turning, a smooth road, an uneven road, a clear road, a traffic jam, a traffic accident, or the like.

It is to be understood that at least one of the weather condition information or the traffic condition information are important factors influencing the safety of vehicle driving. Therefore, after at least one of the weather condition information or the traffic condition information of the geographical area corresponding to the future location information are sent to the vehicle, it facilitates the driver of the vehicle to comprehensively consider at least one of the weather condition information or the traffic condition information and the first driving warning information, thereby facilitating the driver to take countermeasures in advance, thereby improving the safety of vehicle driving.

For example, when the weather condition information received by the vehicle indicates that it is foggy at the geographical area corresponding to the future location information, and the first driving warning information indicates that a situation such as a vehicle collision has occurred at the road ahead, then the driver may reduce the vehicle speed, so as to improve the safety of vehicle driving. For another example, when the traffic condition information received by the vehicle indicates that the geographical area corresponding to the future location information is a road turning area, and the first driving warning information indicates that a pedestrian has traversed the road ahead, then the driver may reduce the vehicle speed to improve the safety of vehicle driving.

FIG. 2 is a structural diagram of an application scenario according to an embodiment of the present disclosure. Referring to FIG. 2, an implementation of acquiring weather condition information of the geographical area corresponding to the future location information may include the follow actions. After predicting the future location information, a cloud platform may send a first query request to a first server which provides a weather service. The first query request is configured to query the weather condition information of the geographical area corresponding to the future location information. After receiving the first query request, the first server executes the query according to the first query request to obtain corresponding weather condition information, and sends the weather condition information to the cloud platform. Thus, the cloud platform may receive the weather condition information sent by the first server.

Referring to FIG. 2, an implementation of acquiring traffic condition information of a geographical area corresponding to the future location information may include the following actions. After predicting the future location information, a cloud platform may send a second query request to a second server which provides the traffic condition information. The second query request is configured to query the traffic condition information of the geographical area corresponding to the future location information. After receiving the second query request, the second server executes the query according to the second query request to obtain corresponding traffic condition information, and sends the traffic condition information to the cloud platform. In this way, the cloud platform may receive the traffic condition information sent by the second server.

In some optional embodiments of the present disclosure, after predicting the future location information based on the real-time location information, the method may further include acquiring at least one of weather condition information or traffic condition information of a geographic region corresponding to the future location information; generating second driving warning information in response to at least one of the weather condition information or the traffic condition information meeting a predetermined warning condition; and sending the second driving warning information to the vehicle.

The warning condition may be set according to an actual application scenario. For example, the warning condition may be that at least one of the weather condition information or the traffic condition information would adversely affect the safety of vehicle driving. Exemplarily, the second driving warning information may be represented in the form of prompt information for prompting at least one of the weather condition information or traffic condition information satisfying the warning condition. In the embodiments of the present disclosure, the implementation of acquiring at least one of the weather condition information or the traffic condition information of the geographical area corresponding to the future location information is described in the foregoing contents, and details are not described herein.

In practical applications, after the cloud platform sends the second driving warning information to the vehicle, the vehicle may display the second driving warning information through the vehicle-mounted display screen, or may broadcast the second driving warning information through voice.

It should be noted that when at least one of the weather condition information or the traffic condition information satisfy the predetermined warning condition, at least one of the weather condition information or the traffic condition information may be ignored.

It may be understood that at least one of the weather condition information or the traffic condition information are important factors influencing the safety of vehicle driving. Therefore, when at least one of the weather condition information or the traffic condition information satisfy the predetermined warning condition, it indicates that at least one of the weather condition information or the traffic condition information may adversely affect the safety of vehicle driving. In this case, after at least one of the weather condition information or the traffic condition information of the geographical area corresponding to the future location information are sent to the vehicle, it is convenient for the driver of the vehicle to comprehensively consider the first driving warning information and the second driving warning information, thereby facilitating the driver to take countermeasures in advance, and improving the safety of vehicle driving.

In the first example, when the second driving warning information received by the vehicle indicates that vehicle collision had occurred at the road ahead, and the first driving warning information indicates that the vehicle collision had occurred at the road ahead, then the driver may reduce the vehicle speed to improve the safety of vehicle driving. In the second example, when the second driving warning information received by the vehicle indicates that it is raining at the road ahead, and the first driving warning information indicates that vehicle overspeed had occurred at the road ahead, then the driver may reduce the vehicle speed to improve the safety of vehicle driving.

In some optional embodiments of the present disclosure, the method for driving warning in the embodiments of the present disclosure may further include: acquiring a facial feature to be analyzed; determining a facial feature of the driver matching the facial feature to be analyzed in a database in which a second mapping relationship between the facial feature of the driver and the dangerous driving history data is stored; acquiring second dangerous driving history data corresponding to the determined facial feature of the driver in the database according to the second mapping relationship; generating third driving warning information based on the first dangerous driving history data and the second dangerous driving history data; and sending the third driving warning information to the vehicle.

In the embodiment of the present disclosure, the facial feature to be analyzed may be a feature extracted from a face image of the driver. In one example, after acquiring the face image of the driver, the vehicle-mounted device may extract the facial feature of the driver from the face image of the driver using a face recognition algorithm, use the facial feature of the driver as the facial feature to be analyzed, and send the facial feature to be analyzed to the cloud platform. In another example, the vehicle-mounted device may send the face image of the driver to the cloud platform after acquiring the face image of the driver, and the cloud platform may extract the facial feature of the driver from the face image of the driver using the face recognition algorithm, and use the facial feature of the driver as the facial feature to be analyzed.

In some optional embodiments, the vehicle-mounted device provided in the vehicle may send the dangerous driving history data and the facial feature of the driver to the cloud platform before acquiring the second dangerous driving history data corresponding to the determined facial feature of the driver in the database. The cloud platform receives the dangerous driving history data and the facial feature of the driver sent by the vehicle-mounted device provided in the vehicle, and may establish a second mapping relationship between the received facial feature of the driver and the received dangerous driving history data according to the received dangerous driving history data and facial feature of the driver in the database, or establish a second mapping relationship between a facial feature of the driver that match the received facial feature of the driver and the received dangerous driving history data in the database.

After establishing the second mapping relationship between the facial feature of the driver and the dangerous driving history data in the database, and when the cloud platform receives the facial feature to be analyzed, the facial feature of the driver matching the facial feature to be analyzed may be determined in the database through feature comparison.

In the embodiment of the disclosure, the second dangerous driving history data acquired according to the second mapping relationship may represent a dangerous driving condition which the driver had experienced.

In the embodiment of the present disclosure, the third driving warning information may be used to indicate that a dangerous driving condition of the driver which is liable to appear at a future location of the vehicle. In practical applications, the first dangerous driving history data indicates a dangerous driving condition which had occurred at the future location of the vehicle, and the second dangerous driving history data indicates a dangerous driving condition which the driver had experienced, and therefore, a dangerous driving condition which the driver had experienced in the future location, i.e., the third driving warning information, may be obtained by comprehensively analyzing the first dangerous driving history data and the second dangerous driving history data.

In practical applications, after the cloud platform sends the third driving warning information to the vehicle, the vehicle may display the third driving warning information through the vehicle-mounted display screen, or broadcast the third driving warning information through voice.

It may be seen that, in the embodiment of the present disclosure, the third driving warning information may indicate that a dangerous driving condition of the driver which is liable to appear at a future location of the vehicle. Therefore, after receiving the third driving warning information, the vehicle may enable the driver of the vehicle to learn accurately and reliably that a dangerous driving condition would easily occur at the road ahead. It may be seen that the third driving warning information is the warning information for the actual driver of the vehicle, thereby facilitating the actual driver of the vehicle to take countermeasures in advance, and improving the safety of vehicle driving.

In an exemplary scenario, driver A sends a facial feature of driver A and a real-time location of the vehicle to a cloud platform when driving the vehicle. On the cloud platform, the second dangerous driving history data corresponding to driver A may be found based on the second mapping relationship, and the second dangerous driving history data indicates that driver A had ever had a behavior such as smoking, drinking, or making up. The first dangerous driving history data indicates that a behavior such as smoking, or drinking had occurred in the future location of the vehicle. By comprehensively analyzing the first dangerous driving history data and the second dangerous driving history data, the third driving warning information may be obtained. The third driving warning information is used to indicate that the driver is prone to behaviors such as smoking and drinking at a future location of the vehicle. In this way, after the vehicle receives the third driving warning information, the driver of the vehicle may learn accurately and reliably that the behaviors such as smoking and drinking would easily occur at the road ahead, thereby facilitating the driver of the vehicle to take countermeasures in advance, and improving the safety of vehicle driving.

In some optional embodiments of the present disclosure, the method for driving warning in the embodiment of the present disclosure may further include: receiving vehicle travel time information; determining third dangerous driving history data corresponding to the vehicle travel time information based on the third mapping relationship between the vehicle travel time information and the dangerous driving history data stored in the database; generating fourth driving warning information based on the first dangerous driving history data, the second dangerous driving history data, and the third dangerous driving history data; and sending the fourth driving warning information to the vehicle.

In the embodiment of the disclosure, the vehicle travel time information may represent at least one of: a time period within one day in which the current time at which the vehicle travels falls, a time period within one month in which the date on which the vehicle travels falls, a season within one year in which the month in which the vehicle travels falls, or the like. For example, when the current time at which the vehicle travels is 9.15 a.m., the time period within one day in which the current time at which the vehicle travels falls may be a time period from 9.00 a.m. to 10.00 a.m. When the date on which the vehicle travels is March 15, the time period within one month in which the date on which the vehicle travels falls may be the 10^{th} day to the 20^{th} day within one month. The foregoing is merely illustrative of the vehicle travel time information, and the embodiment of the disclosure is not limited thereto. In practical applications, the vehicle travel time information may be sent to the cloud platform by the vehicle-mounted device.

In some optional embodiments, before determining the third dangerous driving history data corresponding to the vehicle travel time information, the vehicle-mounted device provided in the vehicle may send the dangerous driving history data and the vehicle travel time information to the cloud platform. The cloud platform receives the dangerous driving history data and the vehicle travel time information sent by the vehicle-mounted device provided in the vehicle, and establishes a third mapping relationship between the received vehicle travel time information and the received dangerous driving history data in the database based on the received dangerous driving history data and vehicle travel time information. After the third mapping relationship is established in the database, and when the cloud platform receives the vehicle travel time information, the third dangerous driving history data corresponding to the received vehicle travel time information may be determined according to the third mapping relationship.

In the embodiment of the present disclosure, the third dangerous driving history data acquired according to the third mapping relationship may represent a dangerous driving condition, which had ever occurred, corresponding to the same vehicle travel time information. For example, the third dangerous driving history data may represent a dangerous driving condition that has occurred within the same time period of different dates, a dangerous driving condition that had occurred within the same time period of different months, a dangerous driving condition that has occurred within the same time period of different years, or the like.

In the present embodiment, the fourth driving warning information may be used to indicate that a dangerous driving condition of the driver which is liable to occur at a future location of the vehicle within the same time period. In practical applications, the first dangerous driving history data indicates a dangerous driving condition at the future location of the vehicle, the second dangerous driving history data indicates a dangerous driving condition which the driver has ever experienced, and the third dangerous driving history data indicates a dangerous driving condition, which has ever occurred, corresponding to the same vehicle travel time information, therefore, the dangerous driving condition at the future location of the vehicle within the same time period may be obtained through analyzing the first dangerous driving history data, the second dangerous driving history data, and the third dangerous driving history data are analyzed comprehensively. That is, the fourth driving warning information may be obtained.

In practical applications, after the cloud platform sends the fourth driving warning information to the vehicle, the vehicle may display the fourth driving warning information through the vehicle-mounted display screen, or broadcast the fourth driving warning information through voice.

It may be seen that, in the embodiment of the present disclosure, the fourth driving warning information may indicate that a dangerous driving condition of the driver which is liable to appear at a future location of the vehicle within the same time period. Therefore, after receiving the fourth driving warning information, the driver of the vehicle may accurately and reliably learn that a situation to the disadvantage of safe driving would easily occur ahead within the same time period. It may be seen that the fourth driving warning information is warning information for the actual driver of the vehicle and the same vehicle travel time information, thereby facilitating the actual driver of the vehicle to take countermeasures in advance, and improving the safety of vehicle driving.

In an exemplary scenario, driver B sends the facial feature of driver B, the vehicle travel time information, and the real-time location of the vehicle to the cloud platform when driving the vehicle. On the cloud platform, the second dangerous driving history data corresponding to driver B may be found according to the second mapping relationship. The second dangerous driving history data indicates that driver B has ever had a behavior such as smoking, drinking, or making up. The third dangerous driving history data corresponding to the vehicle travel time information may be found according to the third mapping relationship. The third dangerous driving history data indicates that a behavior such as smoking, drinking, or the like, is likely to occur within the same time period. The first dangerous driving history data indicates that a behavior such as smoking or drinking has ever occurred at a future location of the vehicle. By comprehensively analyzing the first dangerous driving history data, the second dangerous driving history data, and the third dangerous driving history data, a fourth driving warning information may obtained. The fourth driving warning information is used to indicate that a driver is prone to a behavior such as smoking and drinking at a future location of a vehicle within the same time period. In this way, after the vehicle receives the fourth driving warning information, the driver of the vehicle may accurately and reliably learn that the behavior such as smoking and drinking would easily occur ahead during the same period of time, thereby facilitating the driver of the vehicle to take countermeasures in advance, and improving the safety of vehicle driving.

In some optional embodiments of the present disclosure, the method for driving warning in the embodiments of the present disclosure may further include: receiving a vehicle identifier sent by a vehicle-mounted device; determining fourth dangerous driving history data corresponding to the vehicle identifier based on a fourth mapping relationship between the vehicle identifier and the dangerous driving history data stored in the database; generating fifth driving warning information based on the first dangerous driving history data and the fourth dangerous driving history data; and sending the fifth driving warning information to the vehicle.

In the embodiment of the present disclosure, the vehicle identifier may be a license plate number or other identifier information of the vehicle. In practical applications, the vehicle-mounted device may send the vehicle identifier to the cloud platform.

In some optional embodiments, prior to determining the fourth dangerous driving history data corresponding to the vehicle identifier, the vehicle-mounted device provided on the vehicle may send the dangerous driving history data and the vehicle identifier to the cloud platform, the cloud platform receives the dangerous driving history data and the vehicle identifier sent by the vehicle-mounted device provided on the vehicle, and establishes a fourth mapping relationship between the received dangerous driving history data and the received vehicle identifier in the database based on the received dangerous driving history data and the vehicle identifier. After establishing the fourth mapping relationship between the vehicle identifier and the dangerous driving history data in the database, and when the cloud platform receives the vehicle identifier, the fourth dangerous driving history data corresponding to the vehicle identifier may be determined in the database.

In the embodiment of the disclosure, the fourth dangerous driving history data acquired according to the fourth mapping relationship may represent a dangerous driving condition which has ever occurred to the vehicle.

In the embodiment of the present disclosure, the fifth driving warning information may be used to indicate a dangerous driving condition which is liable to occur to the vehicle at a future location. In practical applications, the first dangerous driving history data indicates a dangerous driving condition which has ever occurred at a future location of the vehicle, and the fourth dangerous driving history data indicates a dangerous driving condition which has ever occurred to the vehicle, therefore, by comprehensively analyzing the first dangerous driving history data and the fourth dangerous driving history data, a dangerous driving condition which is liable to occur to the vehicle at a future location may be obtained. That is, the fifth driving warning information may be obtained.

In practical applications, after the cloud platform sends the fifth driving warning information to the vehicle, the vehicle may display the fifth driving warning information through the vehicle-mounted display screen, or may broadcast the fifth driving warning information through voice.

It may be seen that, in the embodiment of the present disclosure, the fifth driving warning information may indicate a dangerous driving condition which is liable to occur to the vehicle at a future location. Therefore, after the vehicle receives the fifth driving warning information, the driver of the vehicle may accurately and reliably learn that a situation to the disadvantage of safe driving would easily occur ahead. It may be seen that the fifth driving warning information is the warning information for the vehicle, thereby facilitating the driver to take countermeasures in advance, and improving the safety of vehicle driving.

In an exemplary scenario, vehicle A sends the identifier of vehicle A and the real-time location of the vehicle to the cloud platform during the travel. On the cloud platform, the fourth dangerous driving history data corresponding to vehicle A may be found based on the fourth mapping relationship. The fourth dangerous driving history data indicates that vehicle A has ever experienced a travel behavior such as lane departure, forward collision, or overspeed. The first dangerous driving history data indicates that a travel behavior such as lane departure or forward collision has ever occurred at a future location of the vehicle. A fifth driving warning information is obtained by comprehensively analyzing the first dangerous driving history data and the fourth dangerous driving history data. The fifth driving warning information is used to indicate that the vehicle is liable to experience a travel behavior, such as lane departure or forward collision, at a future location. In this way, after vehicle A receives the fifth driving warning information, the driver of the vehicle may accurately and reliably learn that the travel behavior such as lane departure or forward collision is liable to occur to vehicle A, thereby facilitating the driver of the vehicle to take countermeasures in advance, thereby improving the safety of vehicle driving.

In some optional embodiments of the present disclosure, the method for driving warning in the embodiments of the present disclosure may further include: receiving vehicle travel time information; determining third dangerous driving history data corresponding to the vehicle travel time information based on the third mapping relationship between the vehicle travel time information and the dangerous driving history data stored in the database; generating sixth driving warning information based on the first dangerous driving history data, the third dangerous driving history data, and the fourth dangerous driving history data; and sending the sixth driving warning information to the vehicle.

In the embodiment of the present disclosure, the sixth driving warning information may be used to indicate a dangerous driving condition which is liable to occur to the vehicle at a future location within the same time period. In practical applications, the first dangerous driving history data indicates a dangerous driving condition which has ever occurred to the vehicle at a future location, the second dangerous driving history data indicates a dangerous driving condition which has ever occurred to a driver, and the third dangerous driving history data indicates a dangerous driving condition, which has ever occurred, corresponding to the same vehicle travel time information. The fourth dangerous driving history data indicates a dangerous driving condition which has ever occurred to the vehicle. Therefore, by comprehensively analyzing the first dangerous driving history data, the third dangerous driving history data, and the fourth dangerous driving history data, a dangerous driving condition which has ever occurred to the vehicle at a future location within the same time period may be obtained. That is, the sixth driving warning information may be obtained.

In practical applications, after the cloud platform sends the sixth driving warning information to the vehicle, the vehicle may display the sixth driving warning information through the vehicle-mounted display screen, or broadcast the sixth driving warning information.

It may be seen that, in the embodiment of the present disclosure, the sixth driving warning information may indicate a dangerous driving condition which is liable to occur to the vehicle at a future location within the same time period. Therefore, after the vehicle receives the sixth driving warning information, the driver of the vehicle may accurately and reliably learn that a situation to the disadvantage of safe driving would easily occur ahead within the same time period. It may be seen that the sixth driving warning information is warning information for the vehicle and the same vehicle travel time information, thereby facilitating the driver to take countermeasures in advance, and improving the safety of vehicle driving.

In one exemplary scenario, vehicle B sends the identifier of vehicle B, vehicle travel time information, and real-time location of the vehicle to the cloud platform during the travel. On the cloud platform, the fourth dangerous driving history data corresponding to vehicle B may be found based on the fourth mapping relationship, and the fourth dangerous driving history data indicates that vehicle B has ever experienced a travel behavior such as lane departure, forward collision, or overspeed. According to the third mapping relationship, the third dangerous driving history data corresponding to the vehicle travel time information may be found. The third dangerous driving history data indicates that a travel behavior such as lane departure or overspeed is liable to occur within the same time period. The first dangerous driving history data indicates that a travel behavior such as lane departure has ever occurred at a future location. Therefore, the sixth driving warning information may be obtained by comprehensively analyzing the first dangerous driving history data, the third dangerous driving history data, and the fourth dangerous driving history data. The sixth driving warning information is used to indicate that a travel behavior such as lane departure is liable to occur to vehicle B at a future location within the same time period. In this case, after receiving the sixth driving warning information, vehicle B may enable the driver to accurately and reliably learn that the behavior of lane departure is liable to occur to vehicle B within the same time period ahead, thereby facilitating the driver to take countermeasures in advance, and improving the safety of vehicle driving.

In some optional embodiments of the present disclosure, the method for driving warning in the embodiments of the present disclosure may further include: acquiring a facial feature to be analyzed and receiving a vehicle identifier sent by a vehicle-mounted device; determining a facial feature of the driver matching the facial feature to be analyzed in a database in which a second mapping relationship between the facial feature of the driver and the dangerous driving history data is stored; acquiring second dangerous driving history data corresponding to the determined facial feature of the driver according to the second mapping relationship; determining fourth dangerous driving history data corresponding to the vehicle identifier in the database based on the fourth mapping relationship between the vehicle identifier and the dangerous driving history data stored in the database; generating seventh driving warning information based on the first dangerous driving history data, the second dangerous driving history data, and the fourth dangerous driving history data; and sending the seventh driving warning information to the vehicle.

In the embodiment of the present disclosure, the seventh driving warning information may be used to indicate a dangerous driving condition which is liable to occur at a future location when the driver drives the vehicle. In practical applications, the first dangerous driving history data indicates a dangerous driving condition which has ever occurred at a future location, the second dangerous driving history data indicates a dangerous driving condition which has ever occurred to the driver, and the fourth dangerous driving history data indicates a dangerous driving condition which has ever occurred the vehicle. Therefore, a dangerous driving condition which is liable to occur at a future location when the driver drives the vehicle may be obtained by comprehensively analyzing the first dangerous driving history data, the second dangerous driving history data, and the fourth dangerous driving history data. That is, the seventh driving warning information may be obtained.

In practical applications, after the cloud platform sends the seventh driving warning information to the vehicle, the vehicle may display the seventh driving warning information through the vehicle-mounted display screen, or may broadcast the seventh driving warning information through voice.

It may be seen that, in the embodiment of the present disclosure, the seventh driving warning information may indicate a dangerous driving condition which is liable to occur at a future location when the driver drives the vehicle. Therefore, after receiving the seventh driving warning information, the driver of the vehicle may accurately and reliably learn that a situation to the disadvantage of safe driving would easily occur ahead when the driver drives the vehicle. It may be seen that the seventh driving warning information is the warning information for the vehicle and the driver, thereby facilitating the driver to take countermeasures in advance, and improving the safety of vehicle driving.

In an exemplary scenario, driver C sends a facial feature of driver C, an identifier of vehicle C, and a real-time location of vehicle C to the cloud platform when driving vehicle C. On the cloud platform, the second dangerous driving history data corresponding to driver C may be found according to the second mapping relationship. The second dangerous driving history data indicates that driver C has ever experienced a behavior such as making phone calls, overspeeding, making up, or the like. The fourth dangerous driving history data corresponding to vehicle C may be found according to the fourth mapping relationship. The fourth dangerous driving history data indicates that vehicle A has ever experienced a travel behavior such as lane departure, forward collision, or overspeed. The first dangerous driving history data indicates that a travel behavior such as a vehicle overspeed, a forward collision, or the like has occurred at a future location. The seventh driving warning information may be obtained by comprehensively analyzing the first dangerous driving history data, the second dangerous driving history data, and the fourth dangerous driving history data. The seventh driving warning information is used to indicate that a behavior such as an overspeed is liable to occur at a future location when driver C drives vehicle C. In this case, after receiving the seventh driving warning information, vehicle C may enable driver C to accurately and reliably learn that a behavior such as an overspeed is liable to occur ahead when driver C drives vehicle C, thereby facilitating driver C of vehicle C to take countermeasures in advance, and improving the safety of vehicle driving.

In some optional embodiments of the present disclosure, the method for driving warning in the embodiments of the present disclosure may further include: receiving vehicle travel time information; determining third dangerous driving history data corresponding to the vehicle travel time information based on the third mapping relationship between the vehicle travel time information and the dangerous driving history data stored in the database; generating eighth driving warning information based on the first dangerous driving history data, the second dangerous driving history data, the third dangerous driving history data, and the fourth dangerous driving history data; and sending the eighth driving warning information to the vehicle.

In the embodiment of the present disclosure, the eighth driving warning information may be used to indicate a dangerous driving condition which is liable to occur at a future location within the same time period when the driver drives the vehicle. In practical applications, the first dangerous driving history data indicates a dangerous driving condition which has ever occurred at a future location, the second dangerous driving history data indicates a dangerous driving condition which has ever occurred to a driver, the third dangerous driving history data indicates a dangerous driving condition corresponding to the same vehicle travel time information which has ever occurred, and the fourth dangerous driving history data indicates a dangerous driving condition which has ever occurred to a vehicle. Therefore, a dangerous driving condition which is liable to occur at a future location within the same time period when the driver drives the vehicle may be obtained by comprehensively analyzing the first dangerous driving history data, the second dangerous driving history data, the third dangerous driving history data, and the fourth dangerous driving history data. That is, the eighth driving warning information may be obtained.

In practical applications, after the cloud platform sends the eighth driving warning information to the vehicle, the vehicle may display the eighth driving warning information through the vehicle-mounted display screen, or may broadcast the eighth driving warning information through voice.

It may be seen that, in the embodiment of the present disclosure, the eighth driving warning information may indicate a dangerous driving condition which is liable to occur at a future location within the same time period when the driver drives the vehicle. Therefore, after receiving the eighth driving warning information, the driver of the vehicle may accurately and reliably learn that a situation to the disadvantage of safe driving would easily occur ahead within the same time period when the driver drives the vehicle. It may be seen that the eighth driving warning information is warning information for the vehicle, the driver, and the same vehicle travel time information, thereby facilitating the driver to take countermeasures in advance, and improving the safety of vehicle driving.

In an exemplary scenario, driver D sends a facial feature of driver D, an identifier of vehicle D, vehicle travel time information, and a real-time location of vehicle D to the cloud platform when driving vehicle D. On the cloud platform, the second dangerous driving history data corresponding to driver D may be found based on the second mapping relationship. The second dangerous driving history data indicates that driver D has ever experienced a behavior such as making phone calls, overspeeding, making up, or the like. According to the third mapping relationship, third dangerous driving history data corresponding to the vehicle travel time information may be found. The third dangerous driving history data indicates that a travel behavior such as lane departure or overspeed easily occurs within the same time period. According to the fourth mapping relationship, the fourth dangerous driving history data corresponding to vehicle D may be found. The fourth dangerous driving history data indicates that vehicle D has ever experienced a travel behavior such as lane departure, forward collision, or overspeed. The first dangerous driving history data indicates that a behavior such as a vehicle overspeed, a forward collision, or the like has ever occurred at a future location of the vehicle. The eighth driving warning information may be obtained through comprehensive analysis of the first dangerous driving history data, the second dangerous driving history data, the third dangerous driving history data, and the fourth dangerous driving history data. The eighth driving warning information is used to indicate that a behavior such as a overspeed is liable to occur at a future location within the same time period when driver D drives vehicle D. Thus, after receiving the seventh driving warning information, vehicle D may enable driver D to accurately and reliably learn that a behavior such as an overspeed is liable to occur ahead when driving vehicle D, thereby facilitating driver D of vehicle D to take countermeasures in advance, and improving the safety of vehicle driving.

It is to be understood by those skilled in the art that in the above methods in detailed description, the order in which the steps are described does not imply a strict order of execution to constitute any limitation on the implementation, and that the specific order of execution of the steps should be determined in terms of their functions and possible intrinsic logic.

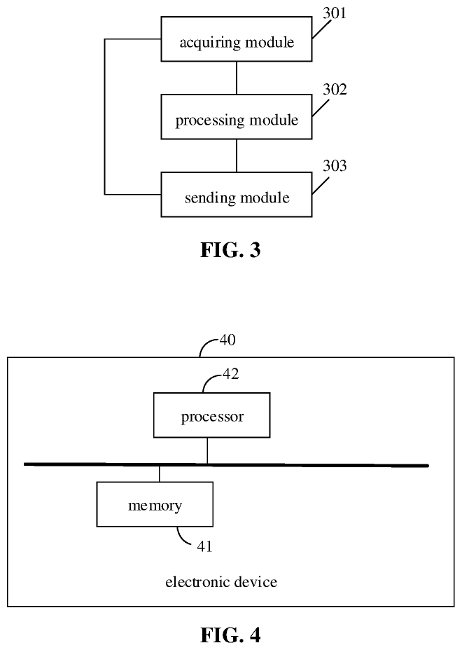

Based on the method for driving warning set forth in the foregoing embodiments, the embodiment of the disclosure provides an apparatus for driving warning. FIG. 3 is a structural diagram of an apparatus for driving warning according to an embodiment of the present disclosure. As shown in FIG. 3, the apparatus includes an acquiring module 301, a processing module 302, and a sending module 303.

The acquiring module 301 is configured to acquire real-time location information of a vehicle.

The processing module 302 is configured to predict future location information based on the real-time location information; determine first dangerous driving history data corresponding to the future location information in the database according to a first mapping relationship between the geographical location and the dangerous driving history data stored in the database; and generate first driving warning information based on the determined first dangerous driving history data.

The sending module 303 is configured to send the first driving warning information to the vehicle.

In some optional embodiments of the present disclosure, the acquiring module 301 is further configured to acquire at least one of weather condition information or traffic condition information of a geographical area corresponding to the future location information.

The sending module 303 is further configured to send at least one of the weather condition information or the traffic condition information to the vehicle.

In some optional embodiments of the present disclosure, the acquiring module 301 is further configured to acquire at least one of the weather condition information or traffic condition information of the geographical area corresponding to the future location information.

The processing module 302 is further configured to generate second driving warning information in response to at least one of the weather condition information or the traffic condition information satisfying a predetermined warning condition.

The sending module 303 is further configured to send the second driving warning information to the vehicle.

In some optional embodiments of the present disclosure, the acquiring module 301 is configured to send a first query request to a first server providing a weather service. Herein, the first query request is configured to query weather condition information of a geographical area corresponding to the future location information; and receive the weather condition information sent by the first server.

In some optional embodiments of the present disclosure, the acquiring module 301 is configured to send a second query request to a second server providing traffic condition information. Herein, the second query request is configured to query traffic condition information of a geographical area corresponding to the future location information; and receive the traffic condition information sent by the second server.

In some optional embodiments of the present disclosure, the processing module 302 is further configured to receive, before determining the dangerous driving history data corresponding to the future location information in the database, the dangerous driving history data and the geographical location corresponding to the dangerous driving history data sent by the vehicle-mounted device provided in the vehicle; and establish a first mapping relationship between the received geographic location and the dangerous driving history data in the database.

In some optional embodiments of the present disclosure, the acquiring module 301 is further configured to acquire a facial feature to be analyzed.

The processing module 302 is further configured to determine a facial feature of the driver matching the facial feature to be analyzed in the database, wherein a second mapping relationship between the facial feature of the driver and the dangerous driving history data is stored in the database; and acquire, according to the second mapping relationship, second dangerous driving history data corresponding to the determined facial feature of the driver in the database; generate third driving warning information based on the first dangerous driving history data and the second dangerous driving history data.

The sending module 303 is further configured to send the third driving warning information to the vehicle.

In some optional embodiments of the present disclosure, the acquiring module 301 is further configured to receive vehicle travel time information.

The processing module 302 is further configured to determine third dangerous driving history data corresponding to the vehicle travel time information based on the third mapping relationship between the vehicle travel time information and the dangerous driving history data stored in the database; and generate fourth driving warning information based on the first dangerous driving history data, the second dangerous driving history data, and the third dangerous driving history data.

The sending module 303 is further configured to send the fourth driving warning information to the vehicle.

In some optional embodiments of the present disclosure, the acquiring module 301 is further configured to receive a vehicle identifier sent by a vehicle-mounted device.

The processing module 302 is further configured to determine fourth dangerous driving history data corresponding to the vehicle identifier according to a fourth mapping relationship between the vehicle identifier and the dangerous driving history data stored in the database; and generate fifth driving warning information based on the first dangerous driving history data and the fourth dangerous driving history data.

The sending module 303 is further configured to send the fifth driving warning information to the vehicle.

In some optional embodiments of the present disclosure, the acquiring module 301 is further configured to receive the vehicle travel time information.

The processing module 302 is further configured to determine third dangerous driving history data corresponding to the vehicle travel time information based on the third mapping relationship between the vehicle travel time information and the dangerous driving history data stored in the database; and generate sixth driving warning information based on the first dangerous driving history data, the third dangerous driving history data, and the fourth dangerous driving history data.

The sending module 303 is further configured to send the sixth driving warning information to the vehicle.

In some optional embodiments of the present disclosure, the acquiring module 301 is further configured to acquire a facial feature to be analyzed and to receive a vehicle identifier sent by a vehicle-mounted device.

The processing module 302 is further configured to determine a facial feature of the driver matching the facial feature to be analyzed in the database, wherein a second mapping relationship between the facial feature of the driver and the dangerous driving history data is stored in the database; acquire, according to the second mapping relationship, second dangerous driving history data corresponding to the determined facial feature of the driver in the database; determine fourth dangerous driving history data corresponding to the vehicle identifier based on a fourth mapping relationship between the vehicle identifier and the dangerous driving history data stored in the database; generate seventh driving warning information based on the first dangerous driving history data, the second dangerous driving history data, and the fourth dangerous driving history data.

The sending module 303 is further configured to send the seventh driving warning information to the vehicle.

In some optional embodiments of the present disclosure, the acquiring module 301 is further configured to receive the vehicle travel time information.

The processing module 302 is further configured to determine third dangerous driving history data corresponding to the vehicle travel time information based on the third mapping relationship between the vehicle travel time information and the dangerous driving history data stored in the database; and generate eighth driving warning information based on the first dangerous driving history data, the second dangerous driving history data, the third dangerous driving history data, and the fourth dangerous driving history data.

The sending module 303 is further configured to send the eighth driving warning information to the vehicle.

In some optional embodiments of the present disclosure, the facial feature to be analyzed is a feature extracted from the face image of the driver.

In some optional embodiments of the present disclosure, the processing module 302 is further configured to receive, before acquiring the second dangerous driving history data corresponding to the determined facial feature of the driver in the database, the dangerous driving history data and the facial feature of the driver sent by the vehicle-mounted device provided in the vehicle; and establish a second mapping relationship between the received facial feature of the driver and the received dangerous driving history data in the database, or establish a second mapping relationship between a facial feature of the driver matching the received facial feature of the driver and the received dangerous driving history data in the database.

In some optional embodiments of the present disclosure, the processing module 302 is further configured to receive, before determining the fourth dangerous driving history data corresponding to the vehicle identifier, the dangerous driving history data and the vehicle identifier sent by the vehicle-mounted device provided in the vehicle, and establish a fourth mapping relationship between the received vehicle identifier and the received dangerous driving history data in the database.

In some optional embodiments of the present disclosure, the processing module 302 is further configured to receive, before determining the third dangerous driving history data corresponding to the vehicle driving time information, the dangerous driving history data and the vehicle driving time information sent by the vehicle-mounted device provided in the vehicle, and establish a third mapping relationship between the received vehicle travel time information and the received dangerous driving history data in the database.

In some optional embodiments of the present disclosure, the dangerous driving history data represents dangerous driving data when at least one driver passes a corresponding geographic location.

In some optional embodiments of the present disclosure, the dangerous driving data includes at least one of: a lane departure warning, a forward collision warning, an overspeed warning, a pedestrian in front of the vehicle, a backward collision warning, an obstacle in front of the vehicle, fatigue driving data of the driver, distracted driving data of the driver, or dangerous action data of the driver.

In practical applications, the acquiring module 301, the processing module 302, and the sending module 303 may all be implemented by a processor in a cloud platform. The processor may be at least one of an ASIC, a DSP, an DSPD, a PLD, an FPGA, a CPU, a controller, a microcontroller, or a microprocessor.

In addition, the functional modules in the present embodiments may be integrated in one processing unit, or each unit may exist alone physically, or two or more units may be integrated in one unit. The integrated units described above may be implemented in the form of hardware or in the form of software functional modules.

The integrated unit, when not sold or used as a stand-alone product in the form of a software functional module, may be stored in a computer-readable storage medium. It is understood that the technical solution of the present embodiment may be embodied in the form of a software product in which instructions are included to cause a computer device (which may be a personal computer, a server, a network device, or the like) or a processor to perform all or part of the steps of the methods described in the present embodiments. The storage medium includes a USB flash drive, a removable hard disk, a Read Only Memory (ROM), a Random Access Memory (RAM), a magnetic disk, or an optical disk.

Specifically, the computer program instructions corresponding to the methods for driving warning in the present embodiments may be stored in a storage medium such as an optical disk, a hard disk, or a USB flash disk. When the computer program instructions corresponding to the methods for driving warning in the storage medium are read or executed by an electronic device, any of the methods for driving warnings in the foregoing embodiments is implemented.

Based on the same technical concept of the foregoing embodiments, referring to FIG. 4, an electronic device 40 is provided according to an embodiment of the present disclosure. The electronic device 40 may include a memory 41 and a processor 42.

The memory 41 is configured to store a computer program and data.

The processor 42 is configured to execute the computer program stored in the memory to implement any one of the methods for driving warnings of the foregoing embodiments.

In practical applications, the memory 41 may be a volatile memory such as a RAM, or non-volatile memory such as ROM, flash memory, Hard Disk Drive (HDD) or Solid-State Drive (SSD), or a combination of memories of the types described above. The memory 41 further provides instructions and data to the processor 42.

The processor 42 may be at least one of an ASIC, a DSP, a DSPD, a PLD, an FPGA, a CPU, a controller, a microcontroller, or a microprocessor. It is to be understood that for different devices, the electronic elements for implementing the above-described processor functions may be other elements, which are not specifically limited in the embodiments of the present disclosure for the sake of simplicity.

In some embodiments, the device provided in the embodiments of the present disclosure may have functions or include modules for performing the methods described in the above method embodiments, and for the specific implementation thereof, references may be made to the abovementioned method embodiments, of which the details are not described herein for brevity.

The foregoing description of the embodiments is intended to emphasize differences between the embodiments, and for the same or similar parts, references may be made to each other, of which the details are not described herein for the sake of brevity.

The embodiment of the disclosure further provides a computer storage medium having stored thereon computer programs which, when executed by a processor, implements any one of the methods for driving warnings described above in the embodiments of the disclosure.

The embodiment of the present disclosure further provide a computer program product including computer program instructions which, when executed, enable a computer to implement any of the methods for driving warnings described above in the embodiments of the present disclosure.

According to the method and apparatus for driving warning, the electronic device and the computer storage medium provided in the embodiments of the present disclosure, real-time location information of a vehicle is acquired; future location information is predicted based on the real-time location information; first dangerous driving history data corresponding to the future location information in the database is determined according to a first mapping relationship between a geographical location and the dangerous driving history data stored in the database; first driving warning information is generated based on the determined first dangerous driving history data; and the first driving warning information is sent to the vehicle. Thus, in the embodiment of the disclosure, not only the real-time location information of the vehicle is acquired, but also the future location of the vehicle is predicted, and the first driving warning information is generated according to the dangerous driving history data corresponding to the future location of the vehicle. The dangerous driving history data indicates the dangerous driving condition at the future location, such that it is possible to reflect accurately and reliably the dangerous driving condition which would easily occur at the road ahead. Further, after the vehicle receives the first driving warning information, the driver of the vehicle may learn accurately and reliably that dangerous driving condition would easily occur at the road ahead, such that the driver may take countermeasures in advance, thereby improving the safety of vehicle driving.

The method embodiments provided in the present disclosure may be combined arbitrarily without conflict to obtain new method embodiments.

The features disclosed in the product embodiments provided in the present disclosure may be combined arbitrarily without conflict to obtain new product embodiments.

The features disclosed in the method or device embodiments provided in the present disclosure may be combined arbitrarily without conflict to obtain new method or device embodiments.

From the above description of the embodiments, it is to be understood by those skilled in the art that the methods of the above embodiments may be implemented by means of software plus a necessary general hardware platform, or may be implemented by means of hardware, but in many cases the former is preferred. Based on such an understanding, the essence or the part contributing to the prior art of the technical solution of the present disclosure may be embodied in the form of a software product stored in a storage medium (such as a ROM/RAM, a magnetic disk, or an optical disk) including instructions for causing a terminal (which may be a mobile phone, a computer, a server, an air conditioner, or a network device) to perform the methods described in the embodiments of the present disclosure.

Embodiments of the present disclosure have been described above in connection with the accompanying drawings, but the present disclosure is not limited to the foregoing detailed description, which is merely illustrative and not restrictive. Many modifications may be made by those of ordinary skill in the art without departing from the spirit of the disclosure and the scope of the claims, all of which are within the protection of the disclosure.

1. A method for driving warning, comprising:
acquiring real-time location information of a vehicle;
predicting future location information based on the real-time location information;
determining first dangerous driving history data corresponding to the future location information according to a first mapping relationship between a geographical location and dangerous driving history data stored in a database;
generating first driving warning information based on the determined first dangerous driving history data; and
sending the first driving warning information to the vehicle.

2. The method of claim 1, wherein the method further comprises:
acquiring at least one of weather condition information or traffic condition information of a geographical area corresponding to the future location information; and
sending at least one of the weather condition information or the traffic condition information to the vehicle.

3. The method of claim 1, wherein the method further comprises:
acquiring at least one of weather condition information or traffic condition information of a geographical area corresponding to the future location information;
generating second driving warning information in response to at least one of the weather condition information or the traffic condition information meeting a predetermined warning condition; and
sending the second driving warning information to the vehicle.

4. The method of claim 2, wherein acquiring the weather condition information of the geographical area corresponding to the future location information comprises:
sending a first query request to a first server providing a weather service, wherein the first query request is configured to query the weather condition information of the geographical area corresponding to the future location information; and
receiving the weather condition information sent by the first server.

5. The method of claim 2, wherein acquiring the traffic condition information of the geographical area corresponding to the future location information comprises:
sending a second query request to a second server providing traffic condition information, wherein the second query request is configured to query the traffic condition information of the geographical area corresponding to the future location information; and
receiving the traffic condition information sent by the second server.

6. The method of claim 1, wherein before determining dangerous driving history data corresponding to the future location information, the method further comprises:
receiving the dangerous driving history data sent by a vehicle-mounted device provided in the vehicle and a geographical location corresponding to the dangerous driving history data; and
establishing, in the database, a first mapping relationship between the received geographical location and the dangerous driving history data.

7. The method of claim 1, wherein the method further comprises:
acquiring a facial feature to be analyzed;
determining a facial feature of a driver matching the facial feature to be analyzed in the database, the database storing a second mapping relationship between the facial feature of the driver and the dangerous driving history data;
acquiring second dangerous driving history data corresponding to the determined facial feature of the driver in the database according to the second mapping relationship;
generating third driving warning information based on the first dangerous driving history data and the second dangerous driving history data; and
sending the third driving warning information to the vehicle.

8. The method of claim 7, wherein the method further comprises:
receiving vehicle travel time information;
determining third dangerous driving history data corresponding to the vehicle travel time information based on a third mapping relationship between the vehicle travel time information and the dangerous driving history data stored in the database;
generating fourth driving warning information based on the first dangerous driving history data, the second dangerous driving history data, and the third dangerous driving history data; and
sending the fourth driving warning information to the vehicle.

9. The method of claim 1, wherein the method further comprises:
receiving a vehicle identifier sent by a vehicle-mounted device;
determining fourth dangerous driving history data corresponding to the vehicle identifier based on a fourth mapping relationship between the vehicle identifier and the dangerous driving history data stored in the database;
generating fifth driving warning information based on the first dangerous driving history data and the fourth dangerous driving history data; and
sending the fifth driving warning information to the vehicle.

10. The method of claim 9, wherein the method further comprises:
receiving vehicle travel time information;
determining third dangerous driving history data corresponding to the vehicle travel time information based on a third mapping relationship between the vehicle travel time information and the dangerous driving history data stored in the database;
generating sixth driving warning information based on the first dangerous driving history data, the third dangerous driving history data, and the fourth dangerous driving history data; and
sending the sixth driving warning information to the vehicle.

11. The method of claim 9, wherein the method further comprises:
acquiring a facial feature to be analyzed and receiving a vehicle identifier sent by a vehicle-mounted device;
determining a facial feature of a driver matching the facial feature to be analyzed in the database, the database storing a second mapping relationship between the facial feature of the driver and the dangerous driving history data;
acquiring second dangerous driving history data corresponding to the determined facial feature of the driver according to the second mapping relationship, and determining fourth dangerous driving history data corresponding to the vehicle identifier based on a fourth mapping relationship between the vehicle identifier and the dangerous driving history data stored in the database;
generating seventh driving warning information based on the first dangerous driving history data, the second dangerous driving history data, and the fourth dangerous driving history data; and
sending the seventh driving warning information to the vehicle.

12. The method of claim 9, wherein the method further comprises:
receiving vehicle travel time information;
determining third dangerous driving history data corresponding to the vehicle travel time information based on a third mapping relationship between the vehicle travel time information and the dangerous driving history data stored in the database;
generating eighth driving warning information based on the first dangerous driving history data, the second dangerous driving history data, the third dangerous driving history data, and the fourth dangerous driving history data; and
sending the eighth driving warning information to the vehicle.

13. The method of claim 11, wherein the facial feature to be analyzed is a feature extracted from a face image of the driver.

14. The method of claim 7, wherein before acquiring the second dangerous driving history data corresponding to the determined facial feature of the driver in the database, the method further comprises:
receiving dangerous driving history data and the facial feature of the driver sent by a vehicle-mounted device provided in the vehicle; and
establishing, in the database, the second mapping relationship between the received facial feature of the driver and the received dangerous driving history data, or establishing, in the database, the second mapping relationship between the facial feature of the driver matching the received facial feature of the driver and the received dangerous driving history data.

15. The method of claim 9, wherein before determining the fourth dangerous driving history data corresponding to the vehicle identifier, the method further comprises:
receiving the dangerous driving history data and the vehicle identifier sent by the vehicle-mounted device provided in the vehicle; and
establishing, in the database, the fourth mapping relationship between the received vehicle identifier and the received dangerous driving history data.

16. The method of claim 8, wherein before determining the third dangerous driving history data corresponding to the vehicle travel time information, the method further comprises:
receiving the dangerous driving history data and the vehicle travel time information sent by a vehicle-mounted device provided in the vehicle; and
establishing, in the database, the third mapping relationship between the received vehicle travel time information and the received dangerous driving history data.

17. The method of claim 1, wherein the dangerous driving history data represents dangerous driving data when at least one driver passes a corresponding geographical location.

18. The method of claim 17, wherein the dangerous driving data comprises at least one of: lane departure warning, forward collision warning, overspeed warning, a pedestrian in front of the vehicle, backward collision warning, an obstacle in front of the vehicle, fatigue driving data of a driver, distracted driving data of the driver, or dangerous action data of the driver.

19. An electronic device, comprising a processor and a memory for storing a computer program executable by the processor; wherein the processor is configured to execute the computer program to:
acquire real-time location information of a vehicle;
predict future location information based on the real-time location information;
determine first dangerous driving history data corresponding to the future location information according to a first mapping relationship between a geographical location and dangerous driving history data stored in a database;
generate first driving warning information based on the determined first dangerous driving history data; and
send the first driving warning information to the vehicle.

20. A non-transitory computer-readable storage medium, having stored thereon a computer program which, when executed by a processor, implements:
acquiring real-time location information of a vehicle;
predicting future location information based on the real-time location information;
determining first dangerous driving history data corresponding to the future location information according to a first mapping relationship between a geographical location and dangerous driving history data stored in a database;
generating first driving warning information based on the determined first dangerous driving history data; and
sending the first driving warning information to the vehicle.
